(19) United States
(12) Patent Application Publication
(10) Pub. No.: US 2026/0227955 A1
(43) Pub. Date: Aug. 6, 2026

(54) EFFICIENT HIGH-PRECISION MATRIX MULTIPLY OPERATIONS

(71) Applicant: NVIDIA Corporation, Santa Clara, CA (US)

(72) Inventors: Victor Podlozhnyuk, Reading (GB); Nikhil Jain, Fremont, CA (US); John Gunnels, Somers, NY (US); Kate Clark, La Crescenta, CA (US)

(21) Appl. No.: 19/249,776

(22) Filed: Jun. 25, 2025

Related U.S. Application Data
(60) Provisional application No. 63/755,077, filed on Feb. 6, 2025.

(51) Int. Cl. G06F 7/487

(52) U.S. Cl. CPC G06F 7/4876

(57) ABSTRACT

Apparatuses, systems, and techniques for efficient high-precision floating-point matrix multiplication using dynamic precision adjustment are disclosed herein. The system may calculate an Exponent Cancellation Degree (ECD) representing potential precision loss during integer-based computation of floating-point matrix multiplication. A guard bit calculator may dynamically determine the required number of additional precision bits based on the calculated ECD value, enabling the system to determine when to use faster integer matrix multiplication accelerator (IMMA) hardware versus floating-point hardware. The system may employ optimization techniques, such as SIMD-compatible uniform extended bit count allocation for matrix tiles, two-tier approximation methods for efficient ECD estimation, and pipelined execution with concurrent processing stages. A specialized sign-magnitude integer format may enable the repurposing of half-precision matrix multiply-accumulate hardware for integer operations with dynamically determined precision.

### CROSS REFERENCE TO RELATED APPLICATIONS

The present application claims priority to U.S. Provisional Patent Application No. 63/755,077, filed Feb. 6, 2025, the entire contents of which is being incorporated herein by reference.

### TECHNICAL FIELD

At least one embodiment pertains to techniques for the efficient computation of floating-point matrix multiplication using dynamic precision adjustment in integer-based hardware.

### BACKGROUND

Parallel processing units can include dedicated circuits to perform particular operations efficiently. For example, a parallel processing unit can include circuits that efficiently execute floating-point operations, such as fused multiply-add (FMA) operations. In some cases, the circuits can be configured to perform high-precision (e.g., 64-bit) FMA operations (e.g., “double-precision” FMA (DFMA) operations). A series of DFMA operations can be performed to operate over a matrix of 64-bit floating-point values.

### BRIEF DESCRIPTION OF THE DRAWINGS

FIG. 1 is a block diagram of a system for performing floating-point matrix multiplication with dynamic guard bit calculation, according to at least one embodiment;

FIG. 2 illustrates the exponent cancellation phenomenon in dot product computation, according to at least one embodiment;

FIG. 3 illustrates an extended bit count (EBC) calculator for matrix multiply tile operations, according to at least one embodiment;

FIG. 4 illustrates functional stages pipelining with multiple dot product batches in flight, according to at least one embodiment;

FIG. 5 illustrates a subsampling approach for estimation of maximum element-wise exponent sums, according to at least one embodiment;

FIG. 6 illustrates a two-tier approximate Exponent Cancellation Degree (ECD) calculation method, according to at least one embodiment;

FIG. 7 illustrates a sign-magnitude integer encoding format that enables integer matrix multiplication using hardware resources designed for floating-point operations, according to at least one embodiment;

FIGS. 8A-8C illustrate different variants of ECD calculation instructions, according to at least one embodiment;

FIG. 9A is a block diagram illustrating a hardware circuit for performing floating-point matrix multiplication operations with dynamic guard bit calculation, according to at least one embodiment;

FIG. 9B illustrates a processor architecture implementing instruction set architecture (ISA) support for dynamic guard bit calculation in floating-point matrix multiplication, according to at least one embodiment; and

FIGS. 10A-10E are flow diagrams of an example method for performing floating-point matrix multiplication operations with dynamic guard bit calculation, according to at least one embodiment.

### DETAILED DESCRIPTION

To increase efficiency of some high-precision floating-point matrix multiply add (MMA) operations, the floating-point values can be converted to fixed-point values and fast integer MMA circuits can be used to perform the operations. To perform an MMA operation on two input matrices using the fast integer MMA circuits, the mantissas of each floating-point value of each input matrix may be aligned such that all values are represented using the same exponent value. For example, a maximum exponent value may be selected from the exponent values of the floating-point values in the first matrix. The mantissa of each floating-point value of the first matrix may then be modified (e.g., shifted) to represent the original floating-point value using the determined maximum exponent value. As a simple example, assume the first matrix includes 2 floating-point numbers. The first floating-point number may have an exponent of 131 and the second floating-point number may have an exponent of 128. Thus, the maximum exponent value of the first matrix may be 131. To represent the second floating-point number using the maximum exponent value (e.g., the exponent of the first floating-point number), the mantissa of the second floating-point number may be shifted by 3 (e.g., 131−128=3). For example, 3 zeros may be prepended to the start of the second floating-point value's mantissa.

The mantissa of each floating-point value of the first matrix can be shifted based on the maximum exponent value of the first matrix, and the mantissa of each floating-point value of the second matrix can be shifted based on the maximum exponent value of the second matrix. The aligned mantissa then can be treated as integer values since they share a common exponent value. The greater the difference between the maximum exponent value and the minimum exponent value, the more the mantissa will be shifted.

Some lower bits (e.g., least significant bits) of the mantissa may be truncated to reduce the number of integer operations that need to be performed. For example, the mantissa corresponding to the floating-point value with the maximum exponent value may not be shifted at all and may be 23 bits long (e.g., for a 32-bit floating-point number). If the mantissa for a particular floating-point value is shifted by 3, its mantissa may become 26 bits long. Lower bits of aligned (i.e., shifted) mantissas beyond a particular threshold (e.g., 30 bits, 36 bits, 40 bits, etc.) may be truncated (e.g., discarded). The bits between the starting value (e.g., 23 bits) and the truncation threshold (e.g., 30 bits) may be known as the “guard bits.” For example, there may be 7 guard bits if the threshold is 30 bits and the smallest mantissa (e.g., the mantissa corresponding to the floating-point value with the maximum exponent value) has 23 bits.

If the floating-point values are within a particular range (e.g., if the number of guard bits needed to represent the mantissas of each value in the first matrix and the number needed for the second matrix are both below a particular threshold), converting the values to fixed-point values and performing the operations using integer circuits can be performed without a loss of precision. However, it can be difficult to determine when it is advantageous to convert the floating-point values to fixed-point values and use the faster integer circuits versus using the slower but more precise floating-point circuits since it can be difficult to determine the appropriate threshold for the number of guard bits to use.

Aspects of the present disclosure address the above and other deficiencies by providing systems and techniques for efficient high-precision matrix multiply operations. The systems and techniques described herein can enable more efficient computation of high-precision floating-point matrix multiplication by dynamically determining when to convert floating-point values to fixed-point representation for processing with faster integer matrix multiply circuits. The system may calculate an Exponent Cancellation Degree (ECD) that measures potential precision loss during conversion. Based on this calculation, the system can maintain numerical accuracy by allocating appropriate guard bits while still improving performance. The system can analyze the exponent values in input matrices to determine the optimal computation path. The system can choose between integer-based computation with extended precision or floating-point operations. This selection process can help find the right balance between speed and accuracy for each matrix operation.

Advantages of the disclosed embodiments over existing technology may include but are not limited to increased high-precision matrix multiply operation efficiency and throughput. The system can achieve maximum performance for each matrix multiplication task by dynamically adjusting precision parameters based on actual input data characteristics rather than using fixed parameters. Specialized hardware circuits may enable parallel processing of multiple dot product operations in a pipelined fashion. These circuits can maintain sufficient numerical precision through innovative exponent handling techniques. The techniques described herein can be particularly valuable for applications requiring both high computational throughput and high numerical precision. Such applications may include scientific computing, machine learning training, and high-fidelity simulations. The ability to dynamically determine the required precision based on data can allow the system to optimize computational resources, reducing unnecessary operations while preserving numerical accuracy.

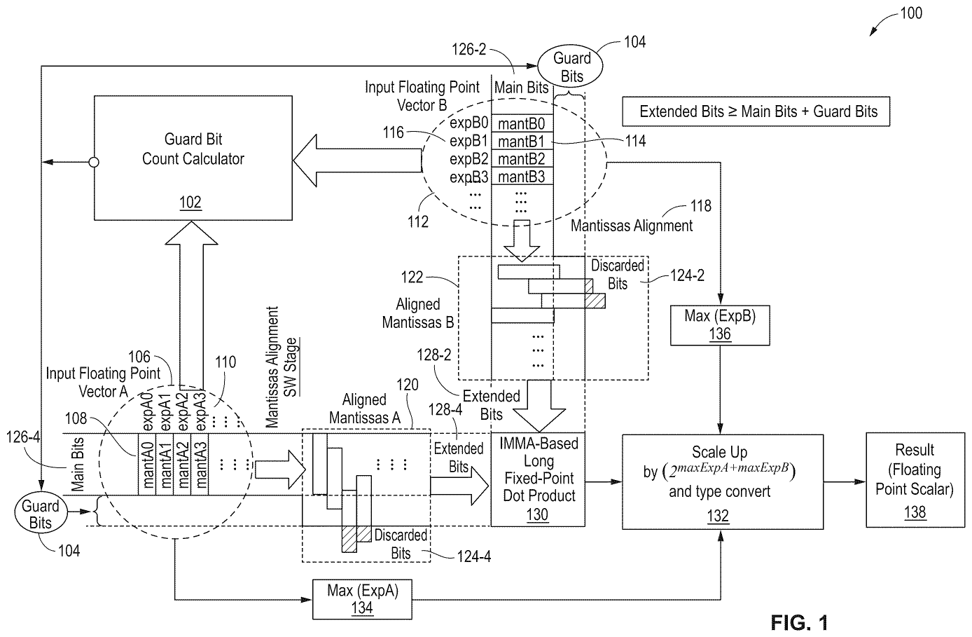

FIG. 1 illustrates a system 100 for performing floating-point matrix multiplication with dynamic guard bit calculation, according to at least one embodiment. The system 100 can include a guard bit count calculator 102 that dynamically determine the required number of guard bits 104 based on the exponent values of input floating-point vectors.

Input floating-point vector A 106 can include mantissa components (e.g., mantA0, mantA1, mantA2, mantA3) 108 and exponent components (e.g., expA0, expA1, expA2, expA3) 110, while input floating-point vector B 112 can include corresponding mantissa components (e.g., mantB0, mantB1, mantB2, mantB3) 114 and exponent components (e.g., expB0, expB1, expB2, expB3) 116.

The system 100 can include a mantissa alignment stage 118 where the mantissas from both vectors can be aligned according to their respective exponents. During alignment, the mantissas may be shifted relative to a common reference point (typically determined by the maximum exponent values) to ensure proper positional weighting during multiplication. This alignment process can result in two aligned mantissa sets, including aligned mantissas A 120 and aligned mantissas B 122.

The alignment process can cause some lower-significance bits to be discarded 124, particularly for mantissas associated with smaller exponents. These discarded bits 124 may represent precision loss. The system 100 can counter this potential precision loss by allocating sufficient guard bits 104 as determined by the guard bit count calculator 102. The mantissas can retain their main bits 126 plus additional extended bits 128. The bit width allocation may be governed by the relationship: extended bits≥main bits+guard bits.

After alignment, the data can flow through an integer MMA (IMMA)-based long fixed-point dot product stage 130, where the integer matrix multiplication accelerator may perform the computation with the extended precision provided by the guard bits. This stage can multiply corresponding elements from vectors A and B and accumulate the results.

A subsequent stage can include scaling and type conversion 132. The scaling operation can apply a factor to adjust the result back to the correct magnitude. This scaling can be applied because during the alignment process, the mantissas were effectively scaled up by a factor proportional to their respective exponents to enable integer computation. The maxExpA 134 and maxExpB 136 values may be forwarded from earlier stages to determine this scaling factor. After scaling, the result may be converted back to floating-point format, producing a result (floating-point scalar) 138.

The system 100 can dynamically adjust precision parameters to balance computational efficiency and numerical accuracy, using only as many guard bits as needed for each specific computation rather than always using a fixed and potentially wasteful number.

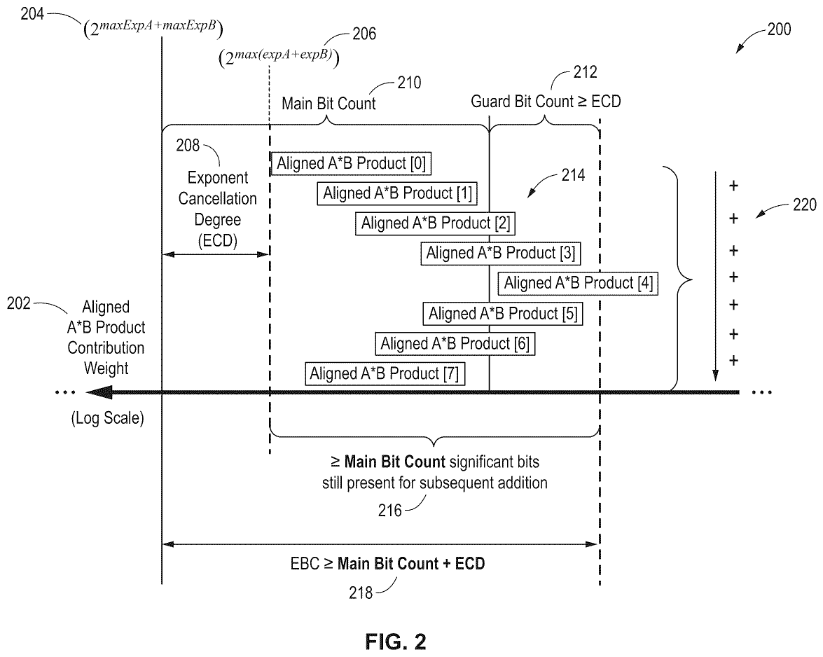

FIG. 2 illustrates the exponent cancellation phenomenon 200 in individual dot product computation, according to at least one embodiment. The diagram shows how different aligned A*B product contributions 202 are positioned on a logarithmic scale according to their weights.

The exponent cancellation degree (ECD) 208 is visualized as the difference between the theoretical maximum exponent (represented by 2\hat{ }(maxExpA+maxExpB) 204) and the actual maximum exponent of any aligned product (represented by 2\hat{ }(max(expA+expB)) 206).

The main bit count 210 represents the number of bits needed to represent the mantissa in its native format. The guard bit count 212 represents the additional bits needed to compensate for the exponent cancellation. The guard bit count 212 can be at least equal to the ECD 208 to prevent precision loss.

The aligned A*B product contributions 214 (labeled [0] through [7]) are shown positioned along the logarithmic scale. The “+” symbols 220 along the right side of the diagram indicate that the aligned products may be added together to produce the final dot product result. Each product contribution may have a specific weight that corresponds to its position on this scale. The contributions with the largest weights (those closest to the 2\hat{ }(max(expA+expB)) mark) contain the most significant bits for the result. Contributions with smaller weights contain less significant bits but may still be important for maintaining precision.

The diagram illustrates that without sufficient guard bits, some of these contributions may be truncated, leading to precision loss. By allocating at least ECD 208 guard bits, the system 100 can ensure that at least main-bit-count-significant bits 216 remain available for subsequent addition operations, as indicated at the bottom of the diagram.

The extended bit count (EBC) 218 is shown as the sum of the main bit count 210 and the ECD 208, expressed as the formula: EBC≥Main Bit Count+ECD. This formula can determine the total bit width needed for integer representations to maintain sufficient precision during computation.

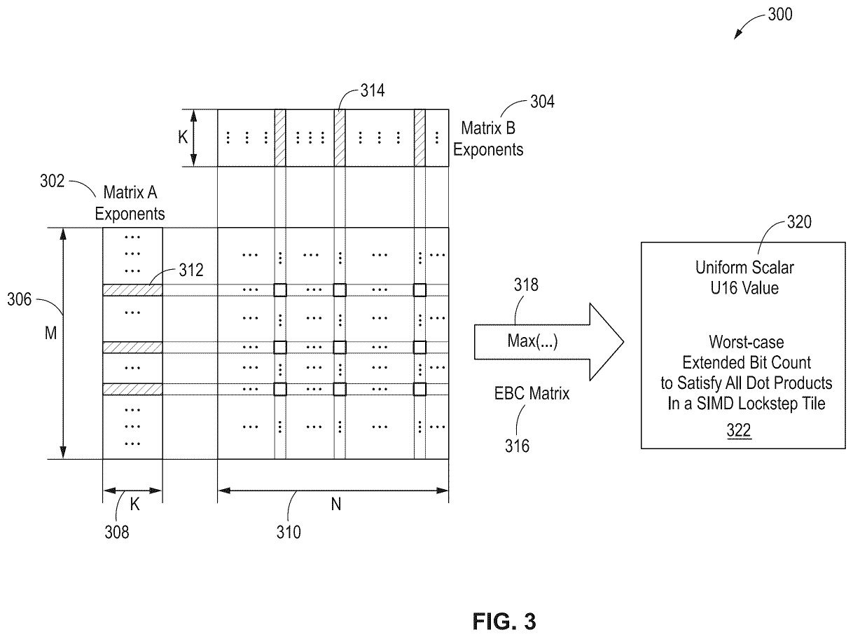

FIG. 3 illustrates an EBC calculator 300 for matrix multiply tile operations, according to at least one embodiment. The diagram shows how a uniform extended bit count value can be determined for efficient parallel processing of matrix multiplication operations.

The diagram depicts two input matrices with their exponent values: matrix A exponents 302 of dimensions M×K and matrix B exponents 304 of dimensions K×N. The dimensions are labeled: M 306 (vertical dimension of matrix A), K 308 (shared dimension between matrices A and B), and N 310 (horizontal dimension of matrix B).

The matrix A exponents 302 can include various exponent values with highlighted areas 312. Similarly, matrix B exponents 304 can include exponent values with highlighted areas 314. These highlighted areas represent regions that may contribute to the exponent cancellation degree calculation.

For efficient computation, particularly in SIMD (Single Instruction, Multiple Data) architectures, an entire processing tile can use the same extended bit count (EBC) value. The system 100 can process the interaction between the exponents in matrices A and B to produce an EBC matrix 316, which reflects the ECD values for different combinations of rows from matrix A and columns from matrix B.

A “Max( . . . )” operation 318 can be applied to this EBC matrix 316 to determine the maximum ECD value across all dot product operations in the tile. This maximum value can then be used to calculate a value 320 (e.g., uniform scalar U16 value), which may represent the worst-case extended bit count needed to satisfy precision requirements for all dot products within the SIMD lockstep tile.

This value 320 may be a worst-case extended bit count 322 to satisfy all dot products in a SIMD lockstep tile, which can ensure consistent precision across parallel operations. By using this uniform value, all processing elements can operate with the same bit width configuration, enabling efficient SIMD parallelism while still maintaining the required precision for every individual dot product calculation.

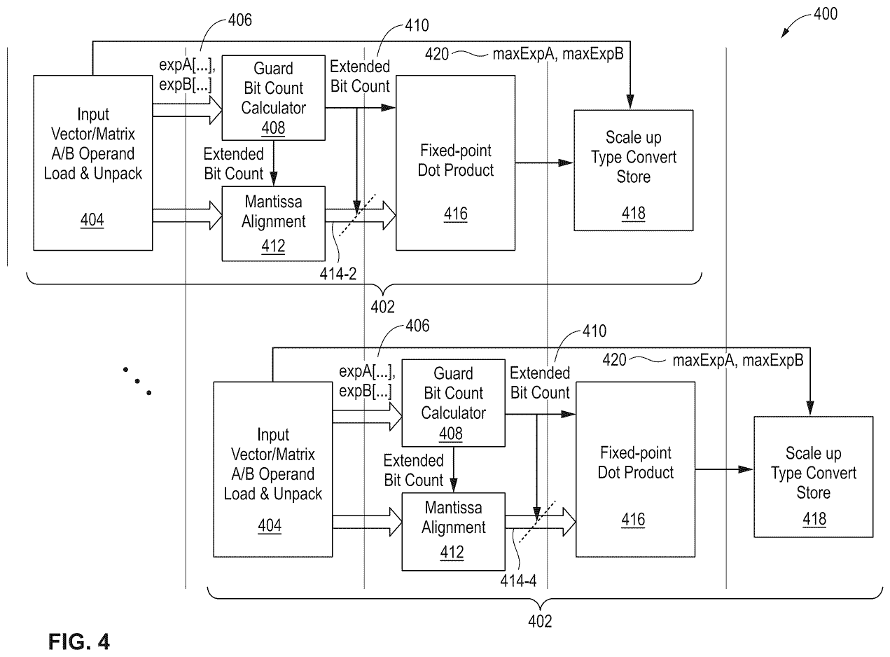

FIG. 4 illustrates functional stages pipelining 400 with multiple dot product batches in flight, according to at least one embodiment. Different processing stages can operate concurrently on different batches of dot product operations to maximize throughput. The diagram shows multiple processing pipelines 402, each handling different dot product operations at various stages of completion. Each pipeline contains several functional stages that process the data sequentially.

Each pipeline can include an input vector/matrix loading and unpacking stage 404, which can load the input operands and extract their components. This stage can provide the exponent values (expA[ . . . ], expB[ . . . ]) 406 from input vectors A and B to the next stage.

The guard bit count calculator stage 408 can analyze these exponent values to determine the required extended bit count (EBC) 410. This EBC value 410 can then be passed to subsequent stages to configure their precision parameters.

The mantissa alignment stage 412 can use the exponent information and EBC value to properly align the mantissas of the input vectors, creating extended precision representations with sufficient guard bits. The aligned mantissas with extended precision 414 can then be passed to the next stage.

The fixed-point dot product stage 416 can perform the actual matrix multiplication operation using integer arithmetic with the extended precision provided by the guard bits. This stage can multiply corresponding elements and accumulate the results to produce an integer dot product result.

The subsequent stage is the scale up, type convert, and store stage 418, which can receive the maximum exponent values (maxExpA, maxExpB) 420 from earlier stages. This stage can apply a scaling factor of 2\hat{ }(maxExpA+maxExpB) to adjust the result to the correct magnitude, convert it back to floating-point format, and store the result.

The diagram shows two processing pipelines operating in parallel, demonstrating how the system 100 can process multiple dot product operations simultaneously. For example, while one operation is in the guard bit count calculator stage 408, a second operation may be in the fixed-point dot product stage 416, and a third operation may be in the scaling and conversion stage 418. This temporal parallelism can significantly increase throughput by keeping processing resources busy and minimizing pipeline stalls.

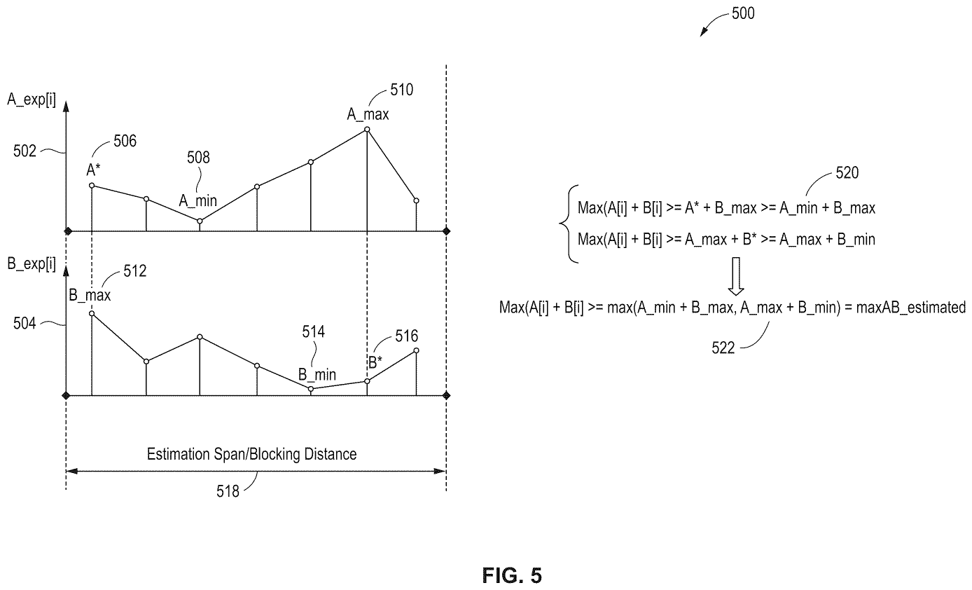

FIG. 5 illustrates a subsampling approach 500 for estimating maximum element-wise exponent sums, according to at least one embodiment. The diagram demonstrates how computational efficiency can be improved while maintaining sufficient precision.

The diagram shows two exponent vectors: A_exp[i] 502 plotted on the upper portion and B_exp[i] 504 plotted on the lower portion. These vectors may represent the exponent values from the first and second input vectors for a dot product operation.

A* 506 may represent a local maximum in vector A near the beginning of the vector, A_min 508 may represent a local minimum, A_max 510 may represent the global maximum, B_max 512 may represent the global maximum in vector B, B_min 514 may represent a local minimum, and B* 516 may represent a local maximum near the end of the vector.

The horizontal span labeled “Estimation Span/Blocking Distance” 518 indicates the window size over which local minimum and maximum values may be determined. Instead of examining every possible combination of exponents from vectors A and B (which would be computationally expensive), the subsampling approach may divide the vectors into blocks and works with block-level statistics.

The mathematical expressions 520 on the right side of the diagram demonstrate the validity of this approach. Max(A[i]+B[i]) (the maximum of element-wise sums) is greater than or equal to both A* (which is >=A_min)+B_max and A_max+B* (which is >=B_min). From these inequalities, it follows that Max(A[i]+B[i]) is greater than or equal to max(A_min+B_max, A_max+B_min), which is defined as maxAB_estimated 522.

Thus, the block-based estimation approach can provide a conservative estimate of the exact maximum value. The block-based estimation could overestimate the required guard bits but may not underestimate them. This property can ensure that the approximation maintains sufficient precision while reducing the computational complexity.

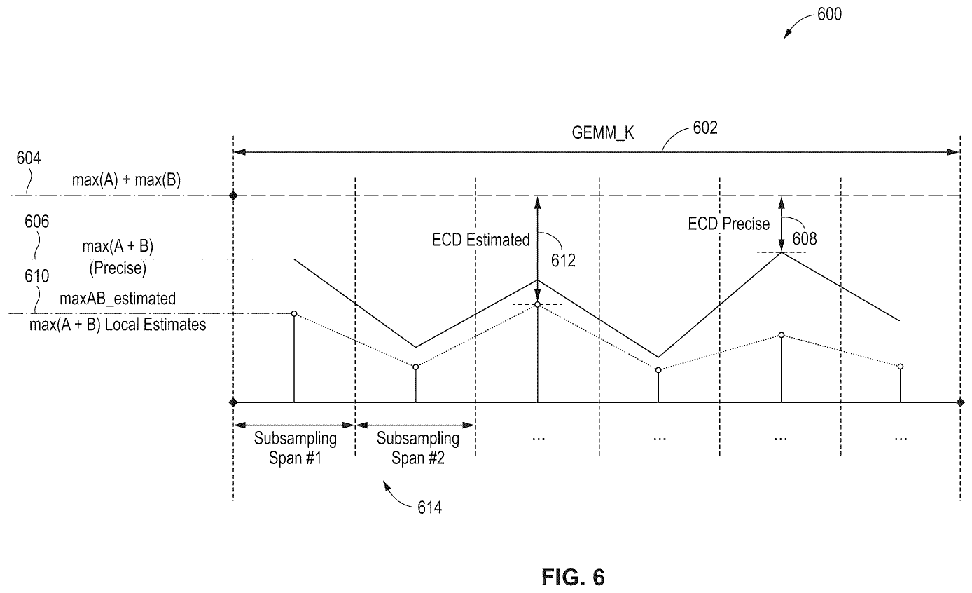

FIG. 6 illustrates a two-tier approximate ECD calculation method 600, according to at least one embodiment. Using the method 600, the system 100 can balance precision requirements with computational efficiency across the entire matrix multiplication operation.

The diagram shows a horizontal axis representing the GEMM_K dimension 602, which can correspond to the shared dimension between the input matrices in a matrix multiplication operation. Along this dimension, the system 100 can perform multiple dot product operations that contribute to the final result.

The diagram depicts three horizontal lines. The top line 604 represents max(A)+max(B), which can be calculated as the sum of the maximum exponent values from vectors A and B. The middle line 606 represents max(A+B) precise, which can be calculated as the exact maximum of element-wise sums of exponents. The difference between lines 604 and 606 can define the precise ECD 608. The bottom dashed line represents maxAB_estimated 610, which can be derived from local estimates using the subsampling approach described in FIG. 5. The difference between line 604 and line 610 can define the estimated ECD 612.

The diagram also shows multiple sampling spans 614 (labeled “Subsampling Span #1”, “Subsampling Span #2”, etc.) along the GEMM_K dimension. Within each span, the system 100 can perform the block-based estimation described in FIG. 5 to determine a local estimate of the maximum exponent sum.

For the two-tier approximation, the estimated ECD 612 can be greater than or equal to the precise ECD 608, which can help ensure that precision is not underestimated. The gap between the estimated and precise values can vary across the GEMM_K dimension, reflecting the varying exponent distributions in different regions of the input matrices. The estimated ECD can follow the general trend of the precise ECD but can provide a smoother, more conservative approximation.

This two-tier approach can reduce computational overhead by avoiding the need to examine every possible pair of exponents while still providing sufficient guard bits to maintain precision. It can allow the system 100 to make efficient decisions about resource allocation and computational paths based on conservative but reasonable estimates of precision requirements.

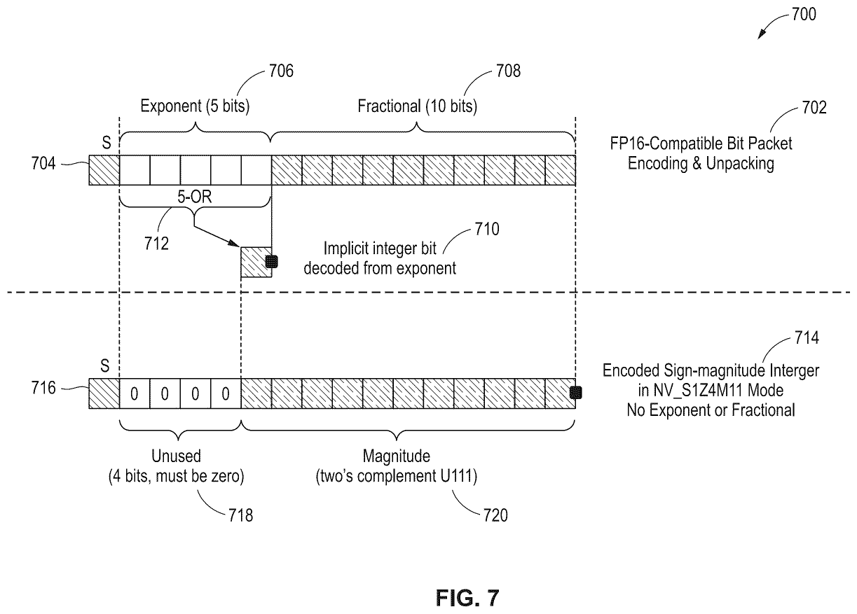

FIG. 7 illustrates a sign-magnitude integer encoding format 700, according to at least one embodiment. The format can enable integer matrix multiplication using hardware resources designed for floating-point operations.

The diagram is divided into two parts by a central dashed line, comparing two different numerical representations. The upper portion shows a floating-point 16-bit (FP 16)-compatible bit packet encoding 702 with a sign bit (S) 704 at the leftmost position, an exponent field (5 bits) 706 containing the biased exponent value, a fractional field (10 bits) 708 containing the fractional part of the mantissa, and an implicit integer bit 710 that is decoded from the exponent value rather than explicitly stored. The 5-OR operation 712 can be used to process the exponent bits, e.g., for identifying special values like zeros, denormals, infinities, and NaNs.

The lower portion shows the format 714 with a sign bit (S) 716 at the leftmost position, which may preserve the sign information, and may include an unused field (4 bits, e.g., zero) 718 that replaces the exponent field, and a magnitude field (11 bits) 720 represented as two's complement unsigned value. The format 714 can correspond to an encoded sign-magnitude integer mode (S1Z4M11) without exponent or fractional parts. This encoding format can allow integer values with extended precision (including guard bits) to be processed by hardware units designed for FP16 operations. The format can be used to preserve the sign bit in the same position as in FP16, set the bits that would normally be used for the exponent to zero, and use the remaining bits (including the bit that would normally be implicit) for the integer magnitude.

By maintaining bit-level compatibility with FP16 formats while representing integer values, the format 714 can allow existing half-precision matrix multiply-accumulate (HMMA) hardware to be repurposed for integer operations with dynamically determined precision. For example, the format can enable instructions like “HMMA D.S32 A.S1Z4M11, B.S1Z4M11, C.S32” to leverage the same hardware that handles “HMMA D.fp32, A.fp16, B.fp16, C.fp32” operations, facilitating the implementation of the guard bit methodology without requiring new hardware designs.

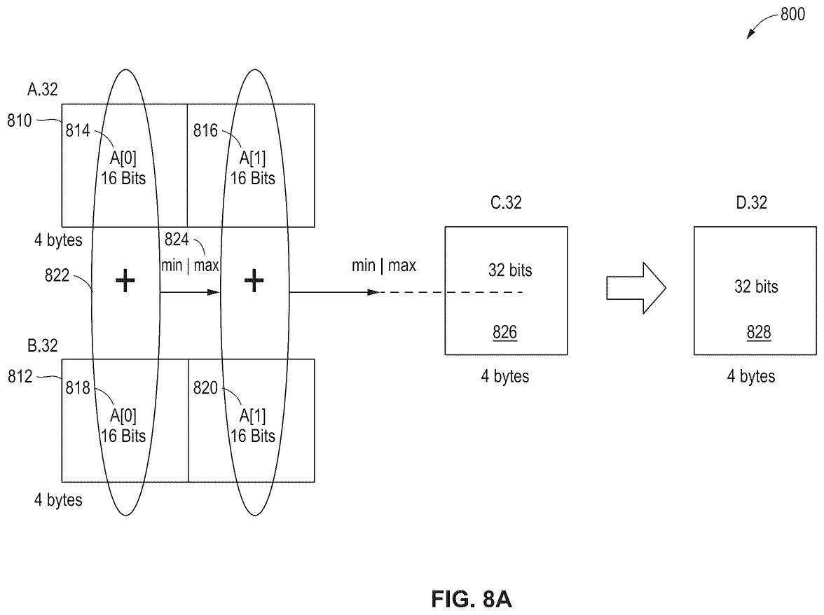

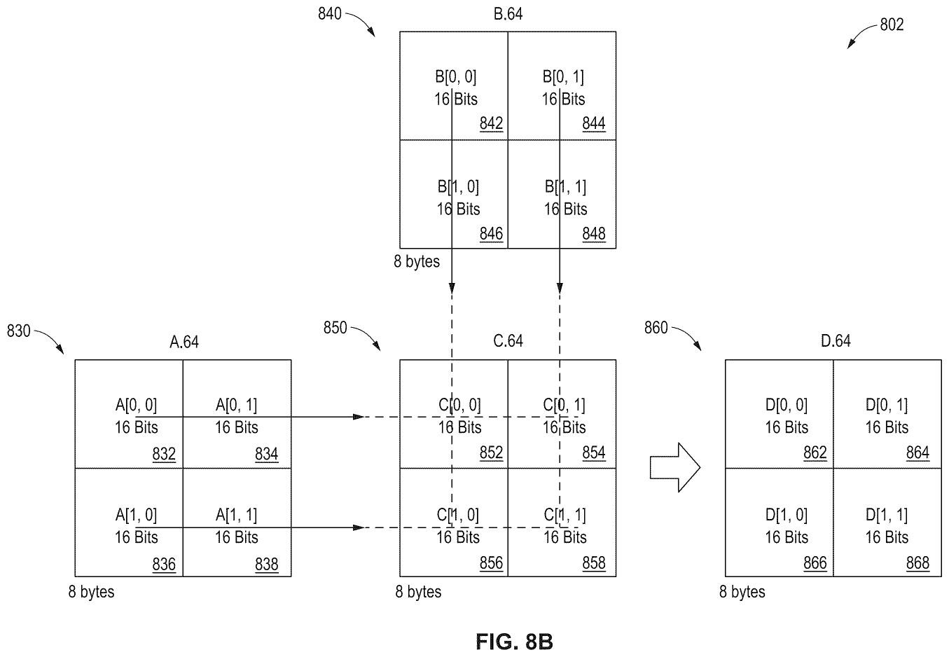

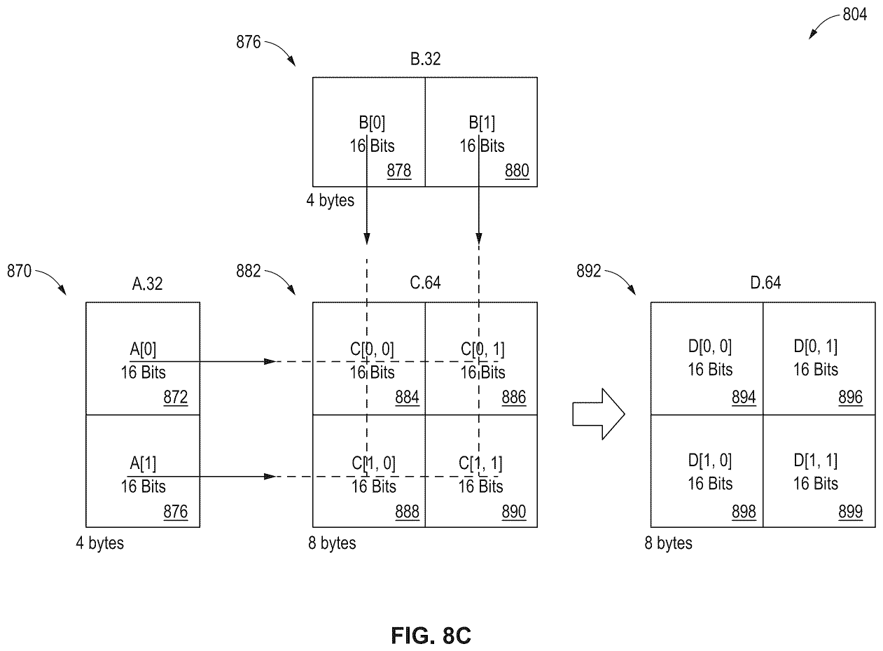

FIG. 8A illustrates an accelerated ECD calculation variant A 800, according to at least one embodiment. The diagram shows the register configuration and functional operation for a specialized instruction that can accelerate exponent cancellation degree calculation. The diagram depicts operand registers A.32 810 and B.32 812, each of which may include 16-bit elements arranged in a 4-byte structure. The A.32 register 810 can include elements A[0] 814 and A[1] 816, while the B.32 register 812 similarly can include elements B[0] 818 and B[1] 820. The diagram shows addition operations 822 (represented by “+” symbols) that can calculate pairwise sums between the corresponding elements from registers A and B. These sums can undergo minimum or maximum operations 824 (represented by “min|max”) as specified by the instruction. The result of these operations can be combined with a value from register C.32 826 (a 32-bit register containing 4 bytes), with the result being stored in destination register D.32 828 (also a 32-bit register). This variant can enable efficient calculation of exponent cancellation degree for scenarios where exponent values can be processed in pairs, which can significantly reduce the computational overhead compared to software-based approaches. An example instruction format may be ECD. {UMIN|SMIN|UMAX|SMAX} D.32, A.32, B.32, C.32, supporting signed and unsigned minimum and maximum operations, which may correspond to a functional definition: D.32:={signed|unsigned min|max}{A.32[0] +B.32[0], A.32[1] +B.32[1], C.32}.

FIG. 8B illustrates an accelerated ECD calculation variant B 802, according to at least one embodiment. This diagram presents a more complex register configuration involving 2×2 matrix-pattern operations. The figure shows 64-bit registers with multiple 16-bit elements arranged in a grid pattern. Register A.64 830 can include four 16-bit elements: A[0,0] 832, A[0,1] 834, A[1,0] 836, and A[1,1] 838, each positioned to represent a 2×2 matrix. Similarly, register B.64 840 can include elements B[0,0] 842, B[0,1] 844, B[1,0] 846, and B[1,1] 848. Register C.64 850 can include corresponding elements C[0,0] 852, C[0,1] 854, C[1,0] 856, and C[1,1] 858. The instruction can perform operations between these registers, with the results stored in destination register D.64 860, which can include four 16-bit elements: D[0,0] 862, D[0,1] 864, D[1,0] 866, and D[1,1] 868. This variant can support more complex matrix-pattern operations, enabling more efficient processing of exponent cancellation degree calculations for two-dimensional arrangements of data, suitable for matrix multiplication tiles. An example instruction format may be ECD64. {UMIN|SMIN|UMAX|SMAX} D.64, A.64, B.64, C.64, where each element D.64[y,x]:={signed|unsigned min|max}{A.64[y,0] +B.64[0,x], A.64[y,1]+B.64[1,x], C.64[y,x]}.

FIG. 8C illustrates an accelerated ECD calculation variant C 804, according to at least one embodiment. This diagram shows a mixed-size variant with 32-bit source registers and 64-bit result registers. The A.32 register 870 can include two 16-bit elements (A[0] 872 and A[1] 874) in a 4-byte structure, while the B.32 register 876 similarly can include two 16-bit elements (B[0] 878 and B[1] 880). However, the C.64 register 882 can be a larger 8-byte structure containing a 2×2 arrangement of 16-bit elements: C[0,0] 884, C[0,1] 886, C[1,0] 888, and C[1,1] 890. The results of operations between these registers can be stored in the destination register D.64 892, which can match the structure of C.64 with four 16-bit elements: D[0,0] 894, D[0,1] 896, D[1,0] 898, and D[1,1] 899. This mixed-size variant can provide flexibility for scenarios where input exponent values may be in a smaller format than the required output precision, offering an efficient middle ground between variants A and B. An example instruction format may be ECD. {UMIN|SMIN|UMAX|SMAX} D.64, A.32, B.32, C.64, where each element D.64[y,x]:={signed|unsigned min|max}{A.32[y] +B.32[x], C.64[y,x] }.

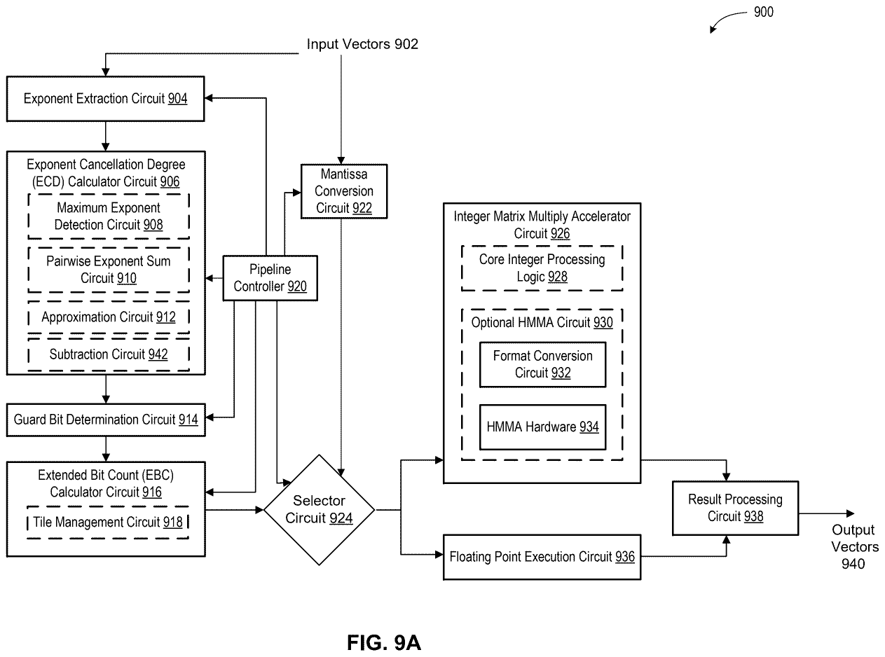

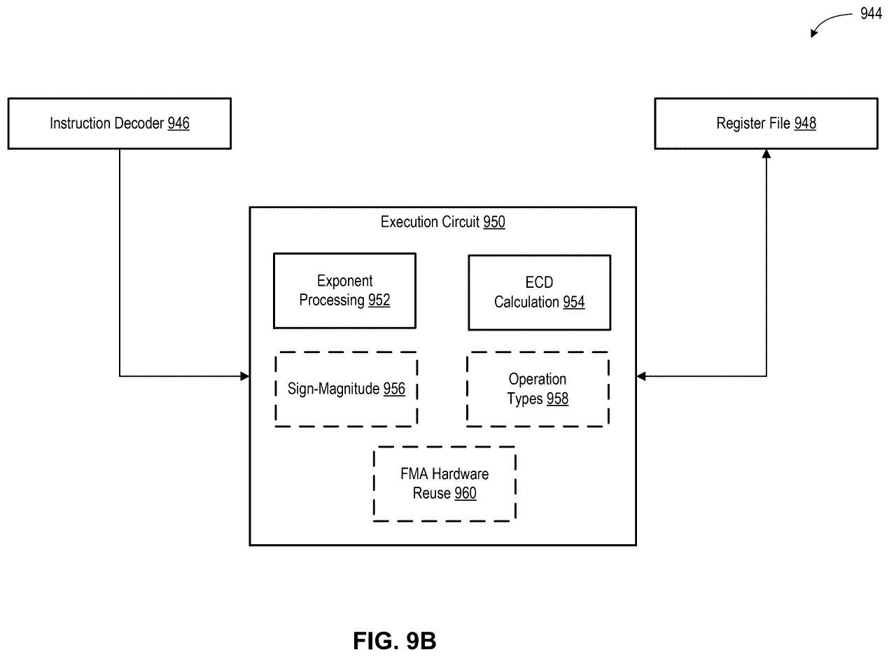

FIG. 9A illustrates a hardware circuit 900 for performing floating-point matrix multiplication operations with dynamic guard bit calculation, according to at least one embodiment. The circuit 900 can receive input vectors 902 from input matrices and processes them through multiple specialized components to efficiently perform matrix multiplication while dynamically adjusting precision.

The exponent extraction circuit 904 can extract the exponent components from the floating-point values in the input vectors. These extracted exponents can be passed to the exponent cancellation degree (ECD) calculator circuit 906, which can determine the potential precision loss that could occur during integer-based computation. The ECD calculator circuit 906 can include a maximum exponent detection circuit 908 that can identify the maximum exponent values in each vector. A pairwise exponent sum circuit 910 can calculate sums of corresponding exponent values between vectors. An approximation circuit 912 can implement the subsampling approach described in FIG. 5 for efficient ECD estimation. A subtraction circuit 942 can calculate the ECD value by subtracting the maximum value obtained from the pairwise exponent sum circuit 910 from the sum of maximum exponent values identified by the maximum exponent detection circuit 908.

The calculated ECD value may be provided to the guard bit determination circuit 914, which can determine the required number of guard bits based on the ECD value. This information may be then passed to the extended bit count (EBC) calculator circuit 916, which may calculate the total bit width needed by adding the mantissa bit width to the required guard bits, as described in FIG. 2. For matrix multiplication operations, a tile management circuit 918 can maintain uniform EBC values across dot product operations within a tile to support SIMD lockstep processing, as illustrated in FIG. 3.

A pipeline controller 920 can coordinate the flow of data between different processing stages, implementing the pipelined execution described in FIG. 4. This controller can manage concurrent operations, allowing guard bit calculation for one dot product to occur simultaneously with mantissa alignment for another dot product operation, for example.

The mantissa conversion circuit 922 can convert the mantissa components of the input floating-point values to integer representations with the appropriate extended bit width, as determined by the EBC calculator circuit 916. The selector circuit 924 can then determine whether to use the integer-based path or the floating-point path based on whether the integer-based approach with the determined guard bits would provide faster execution while maintaining required precision.

If the integer path is selected, the integer matrix multiplication accelerator (IMMA) circuit 926 can process the integer-based dot product operations. This may include core integer processing logic 928 and, optionally, specialized half-precision matrix multiply-accumulate (HMMA) circuitry 930. The optional HMMA circuit 930 can include a format conversion circuit 932 that converts the floating-point values to the sign-magnitude integer format described in FIG. 7, and HMMA hardware 934 that can process these converted values as if they were floating-point values.

If the floating-point path is selected, the floating-point execution circuit 936 can perform the dot product operations using floating-point arithmetic. Regardless of the path selected, the result processing circuit 938 may generate and/or store the resulting floating-point scalar values in the appropriate positions of the output matrix (output vectors 940).

This hardware architecture can combine the performance advantages of integer-based computation with the precision of floating-point operations by dynamically determining the appropriate precision parameters for each dot product operation, enabling efficient high-precision matrix multiplication across a wide range of input data characteristics.

FIG. 9B illustrates a processor architecture 944 implementing instruction set architecture (ISA) support for dynamic guard bit calculation in floating-point matrix multiplication, according to at least one embodiment. The processor architecture 944 can include an instruction decoder 946, a register file 948, and an execution circuit 950. The processor architecture 944 can further include conventional components such as instruction memory, program counter, and instruction scheduling logic (not shown) that can work in conjunction with the illustrated components to fetch, decode, and execute instructions.

The instruction decoder 946 can be configured to decode an Exponent Cancellation Degree (ECD) calculation instruction specifying at least a first source register containing exponent values from a first vector, a second source register containing exponent values from a second vector, and a destination register. The instruction decoder 946 can receive instruction code from an instruction memory (not shown) and can translate the instruction code into specific control signals and operand addresses for the execution circuit 950.

The register file 948 can be coupled to the execution circuit 950 and can be configured to provide source operands to the execution circuit 950 and receive computation results from the execution circuit 950. The register file 948 may include multiple registers that can be addressed by the instruction decoder 946, providing efficient storage for vector elements and exponent values used in matrix multiplication operations.

The execution circuit 950 can function as a computational unit that implements the dynamic guard bit calculation. The execution circuit 950 can include multiple subcomponents, including an exponent processing unit 952, an ECD calculation unit 954, a sign-magnitude integer format converter 956, operation type logic 958, and FMA hardware reuse 960.

The exponent processing unit 952 can extract and process exponent values from the floating-point operands provided by the register file 948. The exponent processing unit 952 can prepare exponent values for further processing by the ECD calculation unit 954 and can coordinate the overall exponent handling operations. The exponent processing unit 952 can function similarly to the exponent extraction circuit 904 described in relation to FIG. 9A but can operate within the processor's instruction set architecture rather than as dedicated hardware.

The ECD calculation unit 954 may support operand size variants, such as a 32-bit variant, a 64-bit variant, and a mixed-size variant. These variants can correspond to the accelerated ECD calculation variants illustrated in FIGS. 8A-8C. The 32-bit variant can process data from 32-bit registers as shown in FIG. 8A, the 64-bit variant can handle 2×2 matrix-pattern operations with 64-bit registers as depicted in FIG. 8B, and the mixed-size variant can work with 32-bit source registers and 64-bit result registers as illustrated in FIG. 8C. The ECD calculation unit 954 can calculate sums of corresponding exponent values from the first source register and the second source register and can determine a maximum or minimum of the sums based on the instruction-specified operation type. The results from the ECD calculation unit 954 can be conceptually similar to those produced by the ECD calculator circuit 906 but can be implemented through processor instructions rather than dedicated circuitry.

The sign-magnitude integer format converter 956 can convert floating-point values to a sign-magnitude integer format that can be bit-compatible with a floating-point format recognized by half-precision matrix multiply-accumulate (HMMA) hardware. This conversion can preserve the sign bit and magnitude bits of floating-point values while eliminating exponent bits, similar to the format conversion circuit 932 shown in FIG. 9A. As illustrated in FIG. 7, this format can allow the processor to use hardware components designed for floating-point operations while performing integer-based computations with dynamically determined precision.

The operation type logic 958 may support different operation types, such as signed minimum (SMIN), unsigned minimum (UMIN), signed maximum (SMAX), and unsigned maximum (UMAX) to be applied to the sums of corresponding exponent values. The operation type logic 958 can select the appropriate operation based on the instruction opcode field, allowing the processor to handle various matrix multiplication scenarios. This can be analogous to the function of the selector circuit 924 in FIG. 9A but may be implemented within the processor's execution pathway.

The FMA hardware reuse 960 can reuse hardware components that implement operations for floating-point multiply-accumulate instructions. Rather than implementing entirely new circuitry for ECD calculations, the processor architecture can repurpose existing FMA hardware components, similar to how the optional HMMA circuit 930 may reuse HMMA hardware 934 in FIG. 9A. This hardware reuse can reduce die area while maintaining computational efficiency.

In operation, an ECD calculation instruction with a format, such as ECD. {UMIN|SMIN|UMAX|SMAX} D, A, B, C can be fetched from instruction memory and decoded by the instruction decoder 946. The register file 948 can then provide the source operands specified by the registers A, B, and C. The execution circuit 950 can process these operands through its various components. The exponent processing unit 952 can extract and prepare the exponent values. The sign-magnitude integer format converter 956 can handle format conversion when needed. The ECD calculation unit 954 can perform the necessary calculations based on the operand size variant being used. The operation type logic 958 can apply the specified operation (UMIN, SMIN, UMAX, or SMAX). The FMA hardware reuse 960 may support these operations by repurposing existing multiply-accumulate hardware. The result can be stored in the destination register D, and the register file 948 can be updated accordingly.

For example, when executing an instruction like ECD. SMIN D.32, A.32, B.32, C.32 (corresponding to the 32-bit variant shown in FIG. 8A), the processor can load 16-bit elements from registers A.32 and B.32, perform addition operations between corresponding elements, find the signed minimum of these sums and the value in register C.32, and store the result in register D.32. Similar processes can occur for the 64-bit variant (corresponding to FIG. 8B) and the mixed-size variant (corresponding to FIG. 8C).

The processor architecture 944 can interface with the matrix multiplication hardware shown in FIG. 9A by providing the calculated ECD values and format-converted operands to the appropriate hardware circuits. The ECD calculation unit 954 can provide data to the ECD calculator circuit 906, the sign-magnitude integer format converter 956 can provide converted operands to the format conversion circuit 932, and the operation type logic 958 can provide control signals to the selector circuit 924. This integration between the processor architecture and dedicated hardware circuits can enable high-precision matrix multiplication operations with dynamic guard bit calculation.

While FIG. 9B illustrates some components of the processor architecture, those skilled in the art can understand that additional conventional components such as instruction memory, instruction fetch units, branch prediction units, load/store units, and data caches may be part of the complete processor implementation but are not shown to maintain clarity and focus on the aspects of the invention.

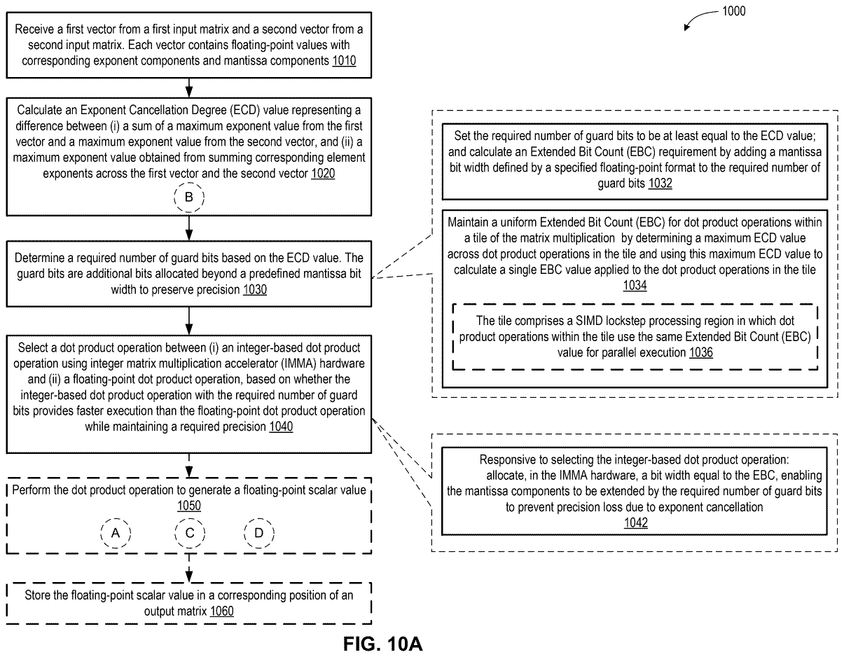

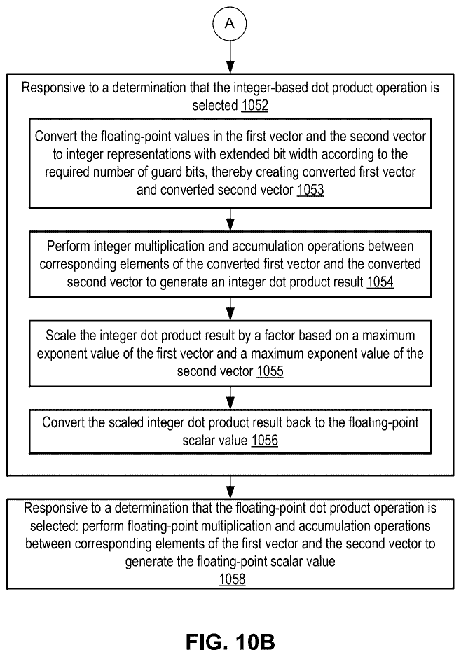

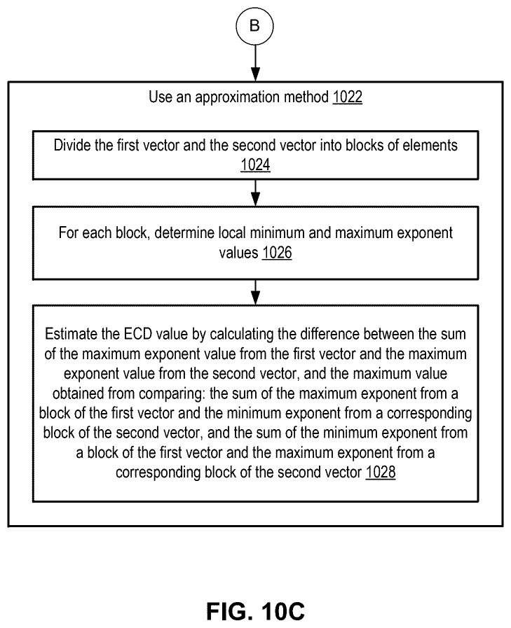

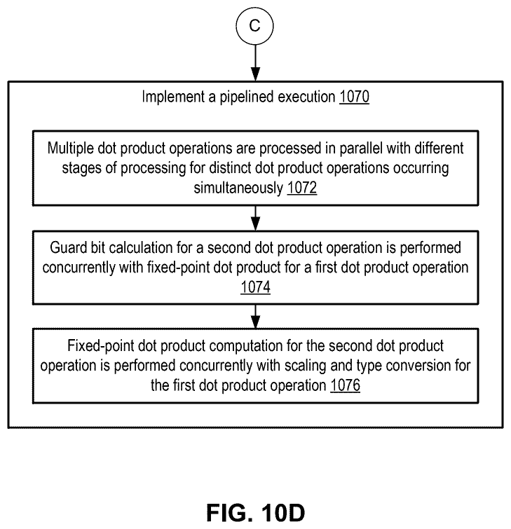

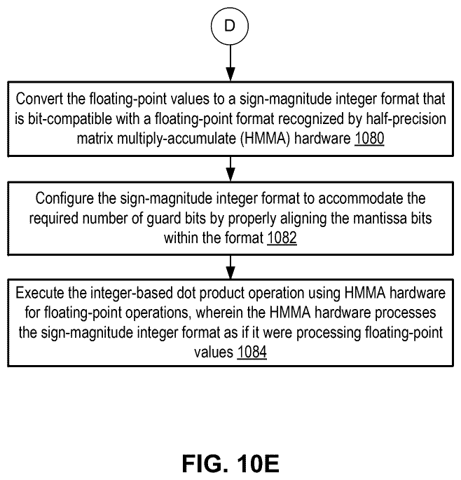

FIG. 10A illustrates a method 1000 for performing floating-point matrix multiplication operations with dynamic guard bit calculation, according to at least one embodiment.

The method may begin at block 1010 where the exponent extraction circuit 904 of FIG. 9A can receive a first vector from a first input matrix and a second vector from a second input matrix. Each vector can include floating-point values with corresponding exponent components and mantissa components. The floating-point values may conform to a specified floating-point format. The first vector and the second vector may correspond to a dot product operation within a floating-point matrix multiplication operation.

At block 1020, the exponent cancellation degree (ECD) calculator circuit 906 can calculate an ECD value representing a difference between (i) a sum of a first maximum exponent value from the first vector and a second maximum exponent value from the second vector, and (ii) a third maximum exponent value obtained from summing corresponding element exponents across the first vector and the second vector. This step may pair each element of the first vector with its corresponding positional element of the second vector and sum their respective exponent values. As illustrated in FIG. 2, the ECD 208 represents the potential precision loss during integer-based computation. In some embodiments, as shown in FIG. 5, the ECD calculator circuit can use an approximation method where it divides the first and second vectors into blocks of elements, determines local minimum and maximum exponent values for each block, and estimates the ECD value using block-level statistics instead of examining every possible combination of exponents.

At block 1030, the guard bit determination circuit 914 can determine a required number of guard bits based on the ECD value. The guard bits are additional bits allocated beyond a predefined mantissa bit width to preserve precision. The mantissa bit width may be defined by the specified FP format. The precision would otherwise be lost due to exponent cancellation occurring when the magnitude differences between values in the first vector and the second vector cause significant bits to be discarded during mantissa alignment for integer-based computation. This step can help reserve numerical precision by preventing the loss of significant bits. In some embodiments, as shown at block 1032, the EBC calculator circuit 916 may set the required number of guard bits to be at least equal to the ECD value and calculate an Extended Bit Count (EBC) requirement by adding a mantissa bit width defined by a specified floating-point format to the required number of guard bits. The EBC may define the total bit width needed for the integer representations to maintain accuracy threshold during integer-based dot product computation. As shown in FIG. 2, the extended bit count (EBC) 218 is the sum of the main bit count 210 and the ECD 208.

In some embodiments, at block 1034, the tile management circuit 918 may maintain a uniform Extended Bit Count (EBC) for dot product operations within a tile of the matrix multiplication by determining a maximum ECD value across dot product operations in the tile and using this maximum ECD value to calculate a single EBC value applied to the dot product operations in the tile (to support SIMD lockstep processing), as illustrated in FIG. 3. In some embodiments, as shown at block 1036, the tile may comprise a SIMD lockstep processing region in which dot product operations within the tile use the same Extended Bit Count (EBC) value for parallel execution. The SIMD lockstep processing region may be a portion of the matrix multiplication that is processed by multiple processing elements operating in synchronous parallel execution, wherein all processing elements within the tile execute identical instructions on different data elements simultaneously.

At block 1040, the selector circuit 924 can select a dot product operation between (i) an integer-based dot product operation using integer matrix multiplication accelerator (IMMA) hardware and (ii) a floating-point dot product operation. This selection may be based on whether the integer-based dot product operation with the required number of guard bits provides faster execution than the floating-point dot product operation while maintaining a required precision. The selection may be determined by comparing the required number of guard bits against a threshold value that defines a crossover point where computational overhead of the integer-based technique exceeds the performance advantage of the IMMA hardware. For example, suppose the throughput of the IMMA circuit 926 is hundred times the throughput of the native higher-precision FP unit. With 13 integer slices, emulation can experience a gating factor of (13*14)/2=91, so the system may select emulation. With 14 integer slices, the slowdown can be (14*15)/2=105, so the system may not select emulation. The required precision may be required numerical accuracy threshold that is comparable to the accuracy provided by the FP technique. The required precision may be set by an application (e.g., set by a test that requires a value be within so many Units of Least Precision (ULPs) of another value).

At block 1050, the system can perform the dot product operation to generate a floating-point scalar value, using either the IMMA circuit 926 or the floating-point execution circuit 936 based on the selection. In some embodiments, as shown at block 1042, responsive to selecting the integer-based dot product operation, the mantissa conversion circuit 922 may allocate a bit width equal to the EBC in the IMMA hardware, enabling the mantissa components to be extended by the required number of guard bits to prevent precision loss due to exponent cancellation.

At block 1060, the result processing circuit 938 can store the floating-point scalar value in a corresponding position of an output matrix.

Referring to FIG. 10B, in some embodiments, at block 1052, responsive to a determination that the integer-based dot product operation is selected, a set of operations shown in blocks 1053-1058 may be performed.

At block 1053, the mantissa conversion circuit 922 can convert the floating-point values in the first vector and the second vector to integer representations with extended bit width according to the required number of guard bits, thereby creating converted first vector and converted second vector.

At block 1054, the IMMA circuit 926 can perform integer multiplication and accumulation operations between corresponding elements of the converted first vector and the converted second vector to generate an integer dot product result.

At block 1055, the result processing circuit 938 can scale the integer dot product result by a factor based on the first maximum exponent value of the first vector and the second maximum exponent value of the second vector.

At block 1056, the result processing circuit 938 can convert the scaled integer dot product result back to the floating-point scalar value.

At block 1058, responsive to a determination that the floating-point dot product operation is selected, the floating-point execution circuit 936 can perform floating-point multiplication and accumulation operations between corresponding elements of the first vector and the second vector to generate the floating-point scalar value.

In some embodiments, referring to FIG. 10D, the pipeline controller 920 can implement a pipelined execution where multiple dot product operations are processed in parallel with different stages of processing for distinct dot product operations occurring simultaneously. Guard bit calculation for a second dot product operation may be performed concurrently with fixed-point dot product for a first dot product operation, and fixed-point dot product computation for the second dot product operation may be performed concurrently with scaling and type conversion for the first dot product operation, as illustrated in FIG. 4.

In some embodiments, referring to FIG. 10E, the format conversion circuit 932 can convert the floating-point values to a sign-magnitude integer format that is bit-compatible with a floating-point format recognized by half-precision matrix multiply-accumulate (HMMA) hardware. The format conversion circuit 932 may configure the sign-magnitude integer format to accommodate the required number of guard bits by properly aligning the mantissa bits within the format. The format conversion circuit 932 may set up the sign-magnitude integer format to accommodate the required number of guard bits by positioning the mantissa bits within the sign-magnitude integer format (e.g., by preserving the sign bit in the leftmost position, setting the exponent field bits to zero, and allocating the remaining bits including what would normally be the implicit bit for the magnitude representation with extended precision), as illustrated in FIG. 7. The HMMA hardware 934 can execute the integer-based dot product operation as if it were processing floating-point values.

Other variations are within the spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, the term “plurality” indicates a state of being plural (e.g., “a plurality of items” indicates multiple items). In at least one embodiment, a number of items in a plurality is at least two but can be more when so indicated either explicitly or by context. Further, unless stated otherwise or otherwise clear from context, the phrase “based on” means “based at least in part on” or “based at least on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in the form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, a set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to the same extent as if each reference were individually and specifically indicated to be incorporated by reference and were set forth in its entirety herein.

In description and claims, terms “coupled” and “connected,” along with their derivatives, may be used. It should be understood that these terms may not be intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, in some embodiments, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, the term “processor” may refer to any device or portion of a device that processes electronic data from registers and/or memory and transforms that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously, or intermittently. In at least one embodiment, terms “system” and “method” are used herein interchangeably insofar as a system may embody one or more methods and methods may be considered a system.

In the present document, references may be made to obtaining, acquiring, receiving, or inputting analog or digital data into a subsystem, computer system, or computer-implemented machine. In at least one embodiment, a process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example embodiments of described techniques, other architectures may be used to implement described functionality and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A method for performing floating-point matrix multiplication operations, the method comprising:
receiving a first vector from a first input matrix and a second vector from a second input matrix, wherein each vector contains floating-point values with corresponding exponent components and mantissa components;
calculating an Exponent Cancellation Degree (ECD) value representing a difference between (i) a sum of a first maximum exponent value from the first vector and a second maximum exponent value from the second vector, and (ii) a third maximum exponent value obtained from summing corresponding element exponents across the first vector and the second vector;
determining a required number of guard bits based on the ECD value, wherein the guard bits are additional bits allocated beyond a predefined mantissa bit width to preserve precision;
selecting a dot product operation between (i) an integer-based dot product operation using integer matrix multiplication accelerator (IMMA) hardware and (ii) a floating-point dot product operation, based on whether the integer-based dot product operation with the required number of guard bits provides faster execution than the floating-point dot product operation while maintaining a required precision;
performing the dot product operation to generate a floating-point scalar value; and
storing the floating-point scalar value in a corresponding position of an output matrix.

2. The method of claim 1, wherein determining the required number of guard bits based on the ECD value comprises:
setting the required number of guard bits to be at least equal to the ECD value; and
calculating an Extended Bit Count (EBC) requirement by adding a mantissa bit width defined by a specified floating-point format to the required number of guard bits.

3. The method of claim 2, further comprising:
responsive to selecting the integer-based dot product operation:
allocating, in the IMMA hardware, a bit width equal to the EBC, enabling the mantissa components to be extended by the required number of guard bits to prevent precision loss due to exponent cancellation.

4. The method of claim 2, further comprising:
maintaining a uniform Extended Bit Count (EBC) for dot product operations within a tile of a matrix multiplication operation by determining a maximum ECD value across dot product operations in the tile and using this maximum ECD value to calculate a single EBC value applied to the dot product operations in the tile.

5. The method of claim 4, wherein the tile comprises a Single Instruction, Multiple Data (SIMD) lockstep processing region in which dot product operations within the tile use the Extended Bit Count (EBC) value for parallel execution.

6. The method of claim 1, wherein performing the dot product operation comprises:
responsive to a determination that the integer-based dot product operation is selected:
converting the floating-point values in the first vector and the second vector to integer representations with extended bit width according to the required number of guard bits, thereby creating converted first vector and converted second vector;
performing integer multiplication and accumulation operations between corresponding elements of the converted first vector and the converted second vector to generate an integer dot product result;
scaling the integer dot product result by a factor based on the first maximum exponent value of the first vector and the second maximum exponent value of the second vector; and
converting the scaled integer dot product result back to the floating-point scalar value; and
responsive to a determination that the floating-point dot product operation is selected:
performing floating-point multiplication and accumulation operations between corresponding elements of the first vector and the second vector to generate the floating-point scalar value.

7. The method of claim 1, wherein calculating the ECD value further comprises using an approximation method comprising:
dividing the first vector and the second vector into blocks of elements;
for each block, determining local minimum and maximum exponent values; and
estimating the ECD value by calculating the difference between the sum of the first maximum exponent value from the first vector and the second maximum exponent value from the second vector, and the third maximum exponent value obtained from comparing: the sum of maximum exponent from a block of the first vector and minimum exponent from a corresponding block of the second vector, and the sum of the minimum exponent from a block of the first vector and the maximum exponent from a corresponding block of the second vector.

8. The method of claim 1, further comprising implementing a pipelined execution wherein:
multiple dot product operations are processed in parallel with different stages of processing for distinct dot product operations occurring simultaneously;
guard bit calculation for a second dot product operation is performed concurrently with fixed-point dot product for a first dot product operation; and
fixed-point dot product computation for the second dot product operation is performed concurrently with scaling and type conversion for the first dot product operation.

9. The method of claim 1, wherein performing the integer-based dot product operation comprises:
converting the floating-point values to a sign-magnitude integer format that is bit-compatible with a floating-point format recognized by half-precision matrix multiply-accumulate (HMMA) hardware;
configuring the sign-magnitude integer format to accommodate the required number of guard bits by aligning the mantissa components within the sign-magnitude integer format; and
executing the integer-based dot product operation using HMMA hardware for floating-point operations, wherein the HMMA hardware processes the sign-magnitude integer format as if it were processing floating-point values.

10. A hardware circuit for performing floating-point matrix multiplication operations, the hardware circuit comprising:
an exponent extraction circuit configured to extract exponent components from floating-point values in a first vector from a first input matrix and a second vector from a second input matrix;
an Exponent Cancellation Degree (ECD) calculator circuit configured to calculate an ECD value representing a difference between a sum of a first maximum exponent value from the first vector and a second maximum exponent value from the second vector, and a third maximum exponent value obtained from summing corresponding element exponents across the first vector and the second vector;
a guard bit determination circuit configured to determine a required number of guard bits based on the ECD value;
an Extended Bit Count (EBC) calculator circuit configured to calculate an EBC requirement by adding a mantissa bit width defined by a specified floating-point format to the required number of guard bits;
a selector circuit configured to select a dot product operation between an integer-based dot product operation and a floating-point dot product operation based on whether the integer-based dot product operation with the required number of guard bits provides faster execution than the floating-point dot product operation while maintaining required precision;
an integer matrix multiplication accelerator (IMMA) circuit having a configurable bit width allocation for processing integer-based dot product operations, wherein a bit width allocation is dynamically configured according to the EBC; and
a result processing circuit configured to generate and store a floating-point scalar value in an output matrix, using the dot product operation.

11. The hardware circuit of claim 10, further comprising:
a mantissa conversion circuit configured to convert mantissa components of the floating-point values to integer representations with extended bit width according to the EBC responsive to selecting the integer-based dot product operation.

12. The hardware circuit of claim 10, wherein the ECD calculator circuit comprises:
a maximum exponent detection circuit configured to identify the first maximum exponent value from the first vector and a second maximum exponent value from the second vector;
a pairwise exponent sum circuit configured to calculate sums of corresponding element exponents between the first and second vectors; and
a subtraction circuit configured to calculate the ECD value by subtracting a maximum of the calculated sums from a sum of the first maximum exponent value and the second maximum exponent value.

13. The hardware circuit of claim 12, wherein the ECD calculator circuit includes an approximation circuit configured to:
divides the first and second vectors into blocks of elements;
determines local minimum and maximum exponent values for each block; and
estimates the ECD value by comparing combinations of block-level minimum and maximum exponents instead of processing individual element exponents.

14. The hardware circuit of claim 10, further comprising:
a tile management circuit configured to determine a maximum ECD value across all dot product operations within a tile of a matrix multiplication operation and use this maximum ECD value to calculate a single uniform EBC applied to all dot product operations in the tile.

15. The hardware circuit of claim 10, further comprising:
a pipeline controller configured to implement concurrent execution of different processing stages for multiple dot product operations, wherein guard bit calculation for a second dot product operation is performed concurrently with fixed-point dot product for a first dot product operation, and wherein fixed-point dot product computation for the second dot product operation is performed concurrently with scaling and type conversion for the first dot product operation.

16. The hardware circuit of claim 10, further comprising:
a format conversion circuit configured to convert the floating-point values to a sign-magnitude integer format that is bit-compatible with a half-precision floating-point format, wherein the sign-magnitude integer format preserves a sign bit, sets exponent bits to zero, and uses remaining bits for magnitude representation with the required number of guard bits; and
half-precision matrix multiply-accumulate (HMMA) hardware configured to process values in the sign-magnitude integer format as if they were floating-point values, thereby performing integer matrix multiplication with the required number of guard bits using hardware resources designed for floating-point operations.

17. A processor implementing instruction set architecture (ISA) support for dynamic guard bit calculation in floating-point matrix multiplication, the processor comprising:
an instruction decoder configured to decode an Exponent Cancellation Degree (ECD) calculation instruction specifying at least a first source register containing exponent values from a first vector, a second source register containing exponent values from a second vector, and a destination register;
execution circuit coupled to the instruction decoder, the execution circuit configured to:
calculate sums of corresponding exponent values from the first source register and the second source register;
determine a maximum or minimum of the sums based on instruction-specified operation type; and
store a result in the destination register for use in determining required guard bits for integer-based matrix multiplication operations; and
register file circuit coupled to the execution circuit, the register file circuit configured to provide source operands to the execution circuit and receive computation results from the execution circuit.

18. The processor of claim 17, wherein the ECD calculation instruction specifies one of signed minimum, unsigned minimum, signed maximum, or unsigned maximum operation types to be applied to the sums of corresponding exponent values.

19. The processor of claim 17, wherein the execution circuit reuses hardware components that implement operations for floating-point multiply-accumulate instructions.

20. The processor of claim 17, wherein the ECD calculation instruction has a format supporting multiple operand size variants, the format comprising ECD. {UMIN|SMIN|UMAX|SMAX} D, A, B, C, wherein:
A specifies the first source register containing exponent values from the first vector;
B specifies the second source register containing exponent values from the second vector;
C specifies a third source register containing a value representing the sum of the maximum exponent values from the first and second vectors; and
D specifies the destination register for storing the result of a minimum or maximum operation between: (i) pairwise sums of corresponding exponent values from registers A and B, and (ii) the value stored in register C.
